(19) United States
(12) Patent Application Publication
(10) Pub. No.: US 2004/0033294 A1
(43) Pub. Date: Feb. 19, 2004

(54) Cooked rice packages and wrappers therefor

(76) Inventors: Makoto Suzuki, Neyagawa-shi (JP); Eiichi Suzuki, Osaka-shi (JP)

Correspondence Address: Arnold B. Silverman, Eckert Seamans Cherin & Mellott, LLC, 44th Floor, 600 Grant Street, Pittsburgh, PA, 15219, US

(21) Appl. No.: 10/353,680

(22) Filed: Jan. 29, 2003

(30) Foreign Application Priority Data
Aug. 13, 2002 (JP) 2002-235512

(51) Int. Cl. A23B 4/00

(52) U.S. Cl. 426/115

(57) ABSTRACT

A cooked rice package comprises a mass of cooked rice having an ingredient and enclosed in a wrapper which comprises a transparent outer film, a transparent inner film and a sheet of layer sandwiched between the two films. The layer sheet has an aperture permitting the ingredient to be seen therethrough without unwrapping the package.

### FIELD OF THE INVENTION

The present invention relates to wrappers comprising an outer film, an inner film and a sheet of food sandwiched between the two films, and to cooked rice packages prepared by enclosing a mass of cooked rice in the wrapper.

### BACKGROUND OF THE INVENTION AND PROBLEM TO BE SOLVED

It is practice to enclose a laterally elongated mass or triangular mass of cooked rice in a wrapper which is prepared by sandwiching a sheet of food between a transparent outer film and a transparent inner film.

Such a rice package is so adapted that only the films of the wrapper can be pulled out with the sheet of food alone left on the mass of rice.

In the packaged state, the food sheet is separated from the outside air and the mass of rice by the outer film and the inner film, is therefore prevented from becoming moist and can be kept fresh and tasty over a long period of time.

Moreover, the food sheet can be seen through the transparent outer film and therefore appears tasty visually.

However, when hand-molded sushi prepared by placing an ingredient atop a laterally slightly elongated mass of cooked rice, or a triangular mass of cooked rice having an ingredient is enclosed in the wrapper described, the food sheet conceals the ingredient from view, so that the name of commodity printed on the outer film of the wrapper is the sole means enabling the consumer to identify the ingredient. In this case, the consumer is unable to recognize details about the ingredient, such as the size, color and shape thereof.

An object of the present invention is to provide a wrapper wherein a sheet of food has an aperture and which, when used for packaging a mass of cooked rice, enables the consumer to see an ingredient atop the mass of rice through a film and the aperture, and to also provide the cooked rice package.

### SUMMARY OF THE INVENTION

The present invention provides a wrapper comprising a transparent outer film, a transparent inner film and a sheet of food sandwiched between the two films, the sheet of food having an aperture formed in a portion thereof corresponding to a front side of a mass of cooked rice.

The present invention provides a cooked rice package comprising a mass of cooked rice having an ingredient on a front side thereof and enclosed in the wrapper, with the aperture in the sheet of food positioned on the front side of the mass of cooked rice.

The sheet of food can be seen through the transparent outer film of the package, so that when such cooked rice packages are arranged in a showcase, the arrangement appears more colorful and attractive than an arrangement of conventional like packages each merely showing a sheet of layer, serving to urge the consumer to purchase these packages more effectively.

Furthermore, the wrapper enables the consumer to select a particular commodity which appears satisfactory to his or her taste with reference to the color or shape of the ingredient on the cooked rice as packaged.

With conventional masses of cooked rice having an ingredient, the ingredient is generally embedded in the central portion of the mass of rice as if being concealed from view. When the rice is to be eaten, the mass is liable to break at the ingredient embedded portion thereof and is therefore difficult to eat.

According to the invention, the ingredient is merely placed on the front side of the mass of rice, which is consequently less likely to break and easy to eat.

### BRIEF DESCRIPTION OF THE DRAWINGS

FIG. 1 is an exploded perspective view of a wrapper according to a first embodiment;

FIG. 2 is a perspective view of the wrapper and a mass of cooked rice;

FIG. 3 is a view in section taken along the line A-A in FIG. 2;

FIG. 4 is a perspective view of the front side of a cooked rice package;

FIG. 5 is a perspective view of the rear side of the cooked rice package;

FIG. 6 is a perspective view of the package at the start of unwrapping thereof;

FIG. 7 is a perspective view of the package as it has been half unwrapped;

FIG. 8 is a perspective view partly broken away and showing an ingredient as placed in a recess formed in a mass of cooked rice;

FIG. 9 is a perspective view partly broken away and showing a wrapper according to a second embodiment;

FIG. 10 is a perspective view showing a triangular mass of cooked rice as placed on the wrapper;

FIG. 11 is a perspective view showing the mass of cooked rice while it is being enclosed in the wrapper;

FIG. 12 is a perspective view of the rear side of a triangular cooked rice package;

FIG. 13 is a perspective view of the front side of the triangular cooked rice package;

FIG. 14 is a view for illustrating how to unwrap the triangular cooked rice package;

FIG. 15 is a diagram for illustrating a separable portion formed in an oriented film;

FIG. 16 is a diagram for illustrating a separable portion provided by a tear tape;

FIG. 17 is a diagram for illustrating a separable portion provided by a heated line; and

FIG. 18 is a view in section taken along a roller in FIG. 17.

### DETAILED DESCRIPTION OF THE PREFERRED EMBODIMENTS

First Embodiment [Barlike Package of Cooked Rice]

[Mass of Cooked Rice]

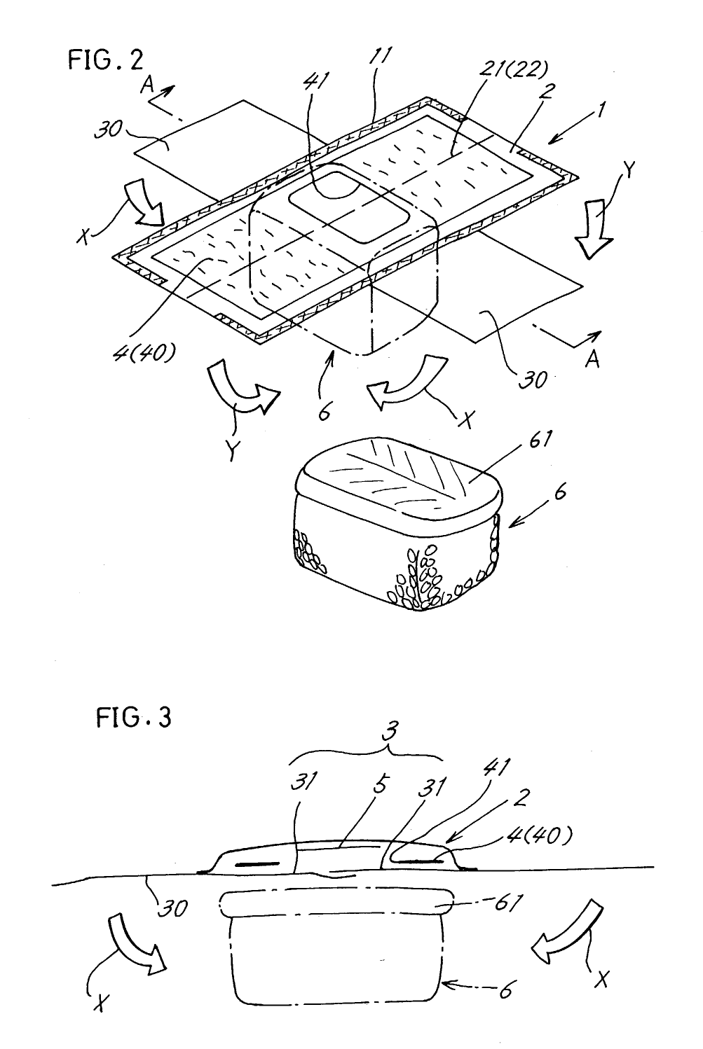

FIG. 2 shows a mass of cooked rice 6 according to this embodiment which has a laterally elongated length of about 70 mm, a generally square to rectangular cross section and an outer peripheral length of about 120 mm.

The mass of cooked rice 6 has an ingredient 61, such as a fillet of fish, placed on the upper surface thereof.

The surface having the ingredient 61 placed thereon is the front side.

[wrapper]

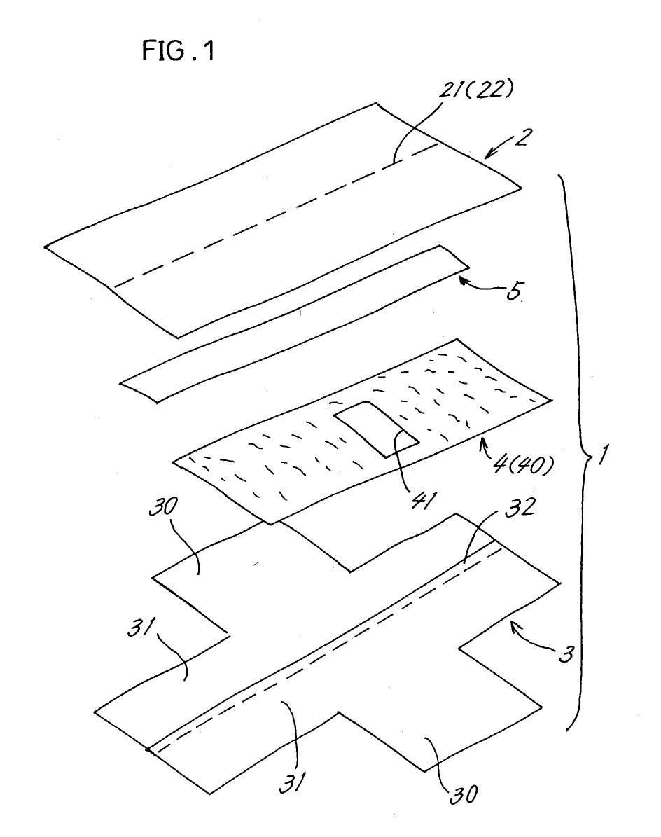

The mass of rice 6 is enclosed in a wrapper 1, which is prepared by sandwiching a rectangular sheet of food 4 between an outer film 2 and an inner film 3 as shown in FIGS. 1, 2 and 3.

The sheet of food 4 of the embodiment is a sheet of layer 40.

The inner film 3 has projecting end covering portions 40 for covering the mass of rice 6. The two films 2, 3 are each a transparent material for the sheet of layer 40 to be seen therethrough from outside.

The sheet of layer 40 is about 140 mm in length and about 70 mm in width. The width is approximately equal to the length of the mass of rice 6, and the length is such that the layer sheet can be wound around the rice mass about 1.2 turns.

The sheet of layer 40 has an aperture 41 permitting the consumer to see the ingredient 61 on the mass of rice therethrough. The aperture 41 is formed by punching the lengthwise central portion of the sheet of layer 40 and is generally in the form of a rectangle which is elongated widthwise of the layer sheet 40. The aperture 41 is about 45 mm in length and about 20 mm in width. The aperture 41 is positioned centrally of the width of the layer sheet 40 without being deflected widthwise toward one side.

The outer film 2 is in the form of a rectangle slightly larger than the layer sheet 40 and has a separable portion 21 extending longitudinally of the film at the midpoint of the width thereof.

The separable portion 21 of the embodiment is provided by making a discrete score 22 in the outer film 2.

The outer film 2 is provided over the inner surface thereof with a closing film strip 5 positioned over the score 22 and extending over the entire length of the outer film 2. The closing film strip 5 serves to prevent outside air from ingressing into the wrapper through the score 22 and protect the layer 40 from moisture.

The inner film 3 is made from rectangular film pieces 31, 31 of approximately the same shape by lapping the longitudinal inner side edges of the film pieces over each other to form a 5- to 10-mm-wide lap. The lap 32 of the film pieces 31, 31 of the embodiment is formed merely by overlapping the side edges of the film pieces, whereas the overlapped side edges may be thermally bonded weakly in the form of spots so as to be separable.

Each of the film pieces 31, 31 has a square to rectangular end covering portion 30 projecting outward from the approximate longitudinal midportion of the outer side edge thereof. The end covering portion 30 is so sized as to wrap the end face of the mass of cooked rice 6 with an allowance.

The outer film 2 and the inner film 3 are thermally bonded in the form of a line along the outer peripheries thereof except at the lap 32 of the inner film pieces 31, 31. When the films are thus bonded as at 11, the closing filmstrip 5 is also thermally bonded to the outer film 2, as positioned over the separable portion 21 of the outer film 2.

[Cooked Rice Package]

To enclose a mass of cooked rice 6 in the wrapper 1, the wrapper 1 is placed, with the inner film 3 down, over the rice 6 with the ingredient 61 facing upward so that the aperture 41 in the sheet of layer 40 is opposed to the ingredient 61 as shown in FIGS. 2 and 3.

Next, the end covering portions 30, 30 are folded inward over the respective end faces of the mass of rice 6 as indicated by arrows X.

Opposite ends of the wrapper 1 are then wound around the peripheral surface of the rice 6 as indicated by arrows Y and lapped over each other on the rear surface of the rice 6.

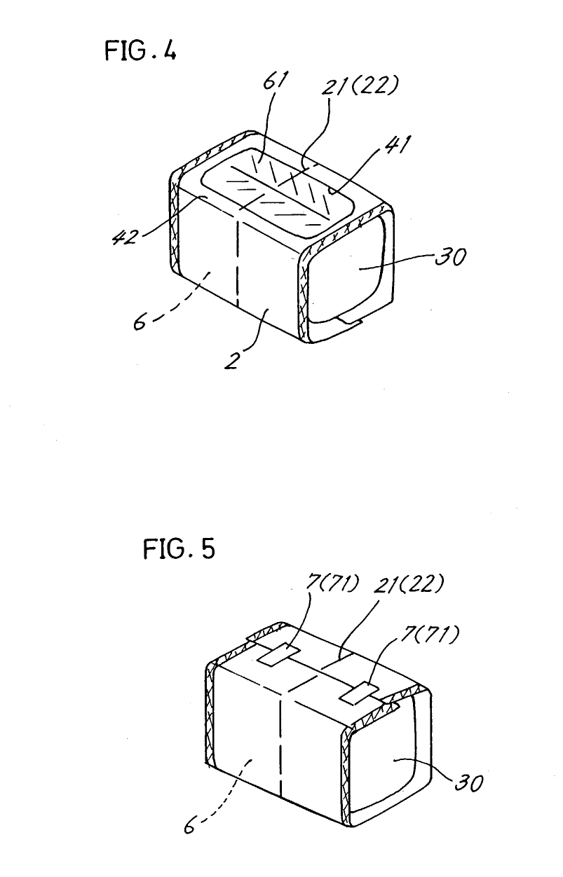

As shown in FIG. 5, the outer edge of the lap of the wrapper 1 is fastened by fastening means 7, 7 such as adhesive seals 71 or weak thermal bonding permitting separation to complete a cooled rice package (see FIGS. 4 and 5).

Since the outer film 2 is separated at the separable portion 21 as will be described later, the fastening means 7, 7 are provided at locations away from the separable portions 21.

With reference to FIG. 4, the sheet of layer 40 can of course be seen through the transparent outer film 2 of the package, and the ingredient 61 on the mass of cooked rice 6 can also be seen through the aperture 41 in the layer sheet 40. When such cooked rice packages are arranged in a commodity showcase, the arrangement therefore appears more colorful and attractive than an arrangement of conventional like packages each merely showing a sheet of layer 40, serving to urge the consumer to purchase these packages more effectively.

Further since a rectangular frame 42 is formed around the aperture 41 by the sheet of layer 40, the contrast between the dark frame 42 and the ingredient 61 gives a vivid fresh appearance to the ingredient 61 to achieve an improved display effect.

The consumer can identify the ingredient on the packaged cooked rice and select a particular commodity which appears satisfactory to his or her taste with reference to the colors or shapes of the ingredients in such cooked rice packages.

The layer sheet 40 is sandwiched between the outer film 2 and the inner film 3 and separated from the outside air or the moisture of the cooked rice 6. Accordingly, the layer sheet 40 retains a crisp feel when eaten.

The outside air is prevented from ingressing into the wrapper through the separable portion 21 of the outer film 2 since this portion 21 is closed with the film strip 5.

With the inner film 3 wound around the mass of cooked rice 6 and with the end covering portions 30, 30 fitting over the end faces of the rice, the wrapper prevents extraneous matter from entering the package to ensure sanitation, further precluding the cooked rice 6 from drying to enable the rice to retain its taste and flavor.

[When the Mass of Cooked Rice is to be Eaten]

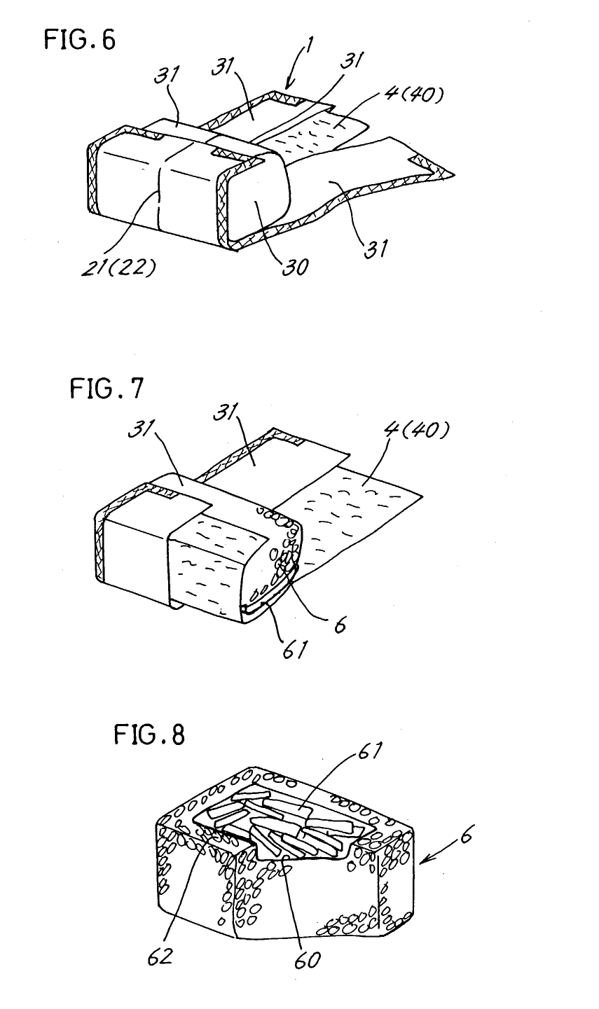

When the cooked rice package is to be eaten, the adhesive seals 71, 71 are removed, and the wrapper 1 is partly unfolded as seen in FIG. 6. With the wrapper 1 held by one hand at one side of the separable portion 21, the outer end of the other side thereof as held by the other hand is pulled toward a direction orthogonal to the separable portion 21. The outer film 2 has the discrete score 22 and can therefore be torn apart easily along the score 22.

The outer film 2 is torn into two pieces along the separable portion 21. Half of the outer film 2 and one of the film pieces 31 of the inner film 3 thermally bonded to this film portion are pulled out together.

At this time, the end covering portion 30 integral with the film piece 31 is also pulled out, exposing one end face of the mass of rice 6 and widthwise half of the layer sheet 40 as shown in FIG. 7.

Next, while holding the exposed portion of the rice 6 with one hand over the layer sheet 40, the remaining half of the wrapper 1 around the rice 6 is pulled outward at an end portion thereof with the other hand, whereby the mass of rice 6 and the layer sheet 40 are entirely exposed, with the rice 6 partly covered with the layer sheet 40.

The closing film strip 5 is pulled out along with half of the outer film 2 when the first half of the outer film 2 as divided into two pieces along the separable portion 21 is pulled out or when the remaining half thereof is pulled out.

The unfolded layer sheet 40 is wound around the mass of cooked rice 6, which is then eaten.

The wrapper 1 can be separated into halves along the length thereof, and the halves can be pulled out individually as described above, so that the mass of rice 6 will not be subjected fully to the tensile friction between the wrapper 1 and the rice 6 at a time. The mass of rice 6 is accordingly almost unlikely to collapse.

The sheet of layer 40 has such a length that the sheet is wound around the mass of rice 6 approximately 1.2 turns, and the aperture 41 in the lengthwise midportion thereof is positioned on the front side of the rice 6. As a result, opposite ends of the layer sheet 40 overlap on the rear side of the mass of rice 6. When the mass of rice 6 is held with fingers placed on the opposite lateral sides and the rear side of the mass of rice 6, rice grains are unlikely adhere to the fingers, and the rice 6 can be eaten without soiling the fingers.

FIG. 8 shows another embodiment of laterally elongated mass of cooked rice 6 which has a recess 60 formed in its upper surface (front side), with an ingredient 61, such as flakes of dried bonito, kombu (kelp) or tuna, placed in the recess 60.

The recess 60 has approximately the same size as the aperture 41 in the sheet of layer 40.

The ingredient 61 is used approximately in such an amount as to fill up the recess 60. If the ingredient 61 is heaped up to a level higher than a peripheral frame portion 62 of rice 6 around the recess 60, trouble will occur during automatic packaging, while the wrapper 1 providing the package will be bulged to an unsightly shape by the ingredient 61. Second Embodiment [Triangular Package of Cooked Rice]

[Mass of Cooked Rice]

FIG. 13 shows a triangular cooked rice package prepared by enclosing a triangular mass of cooked rice 6a in a wrapper 1 like the wrapper of the first embodiment.

The triangular mass of cooked rice 6a is generally in the form of a flat regular triangular prism measuring about 75 mm in the length of each side and about 30 mm in thickness.

As shown in FIG. 10, one of the two triangular surfaces of the mass of rice 6a is the front side, and a triangular recess 60 is formed in the front side for accommodating an ingredient, such as flakes of bonito, kombu (kelp) or tuna. As is the case with the laterally elongated mass of rice 6 shown in FIG. 8, the ingredient 61 is used approximately in such an amount as to fill up the recess 60.

[Wrapper]

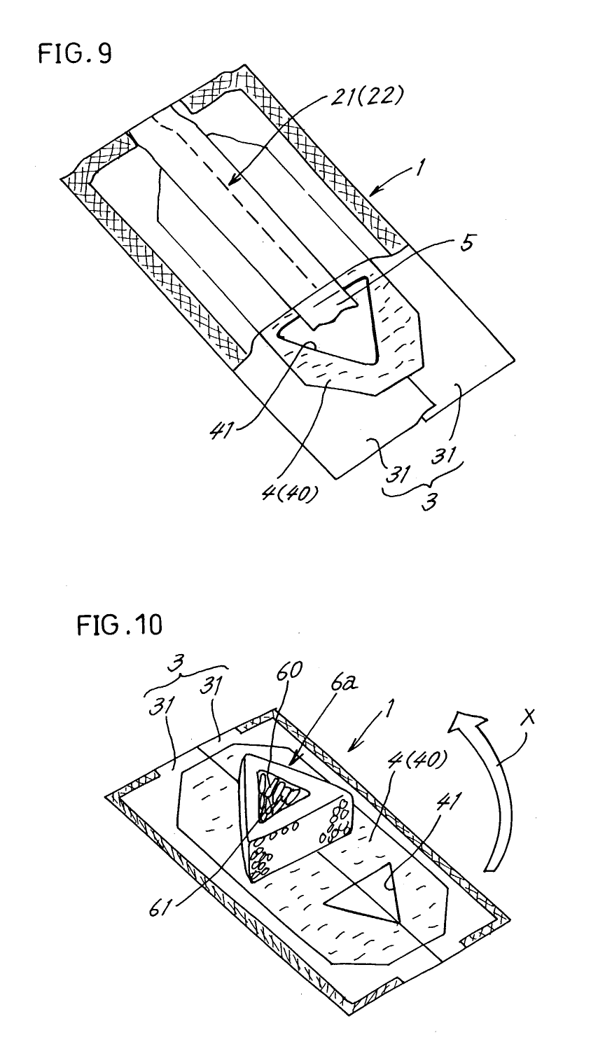

As shown in FIG. 9, the wrapper 1 is the same as the wrapper of the first embodiment in basic construction, but differs therefrom in size, and the position and shape of an aperture 41 in the sheet of layer 40. Another difference is that the two film pieces 31, 31 of the inner film 3 have no square to rectangular end covering portions 30, 30.

The sheet of layer 40 is about 190 mm in length and about 100 mm in width, and has a triangular aperture 41 positioned toward one end thereof and slightly larger than the triangular surface of the mass of cooked rice 6a.

The aperture 41 is formed by punching the sheet of layer 40 and has a vertex opposed to the midportion of an end edge of the layer sheet and a side orthogonal to the lengthwise direction of the layer sheet.

The layer sheet 40 has four corners which are cut obliquely.

[Cooked Rice Package]

To enclose the triangular mass of cooked rice 6a in the wrapper 1 described, the triangular mass of rice 6a is placed on the inner film 3 of the wrapper 1, with the ingredient 61 up as shown in FIG. 10. At this time, the mass of rice 6a is so placed on the wrapper that the rice 6a and the triangular aperture 41 of the layer sheet 40 are positioned and oriented symmetrically about the lengthwise center of the wrapper 1.

The apertured half of the wrapper 1 is folded toward the triangular mass of rice 6a as indicated by an arrow X in FIG. 10 and placed over the front side of the rice 6a, with the aperture 41 of the layer sheet 40 positioned in corresponding relation with the ingredient 61 on the rice 6a.

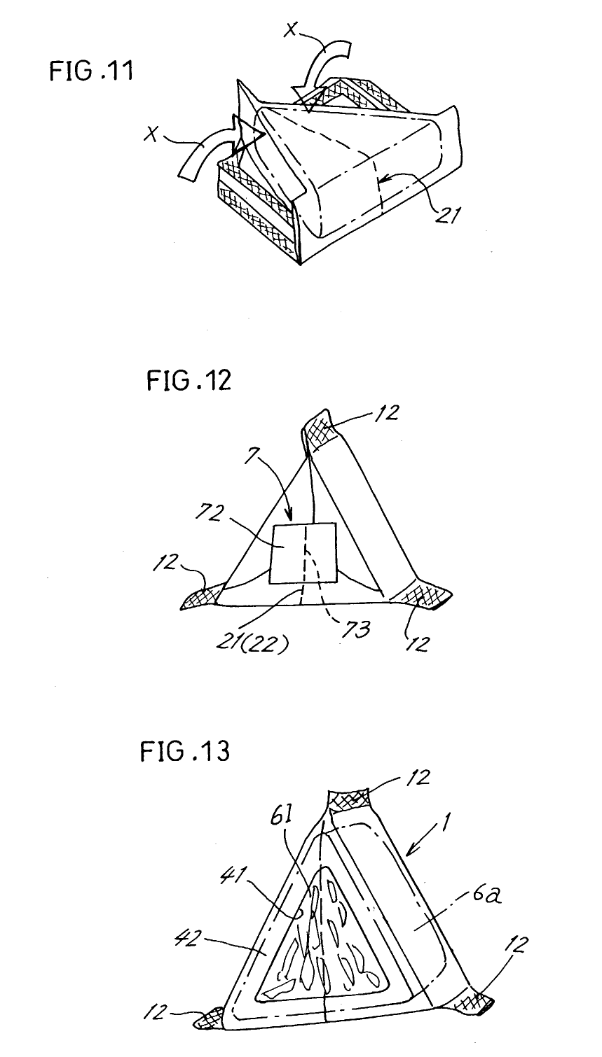

The opposite corners of the folded half of the wrapper 1 are lapped over the opposite corners of the other end of the wrapper 1 as seen in FIG. 11.

The corner laps of the wrapper 1 are then folded toward the rear side of the triangular mass of rice 6a as indicated by arrows X in FIG. 11.

A label 72 is affixed to the folded end portions on the rear side of the rice 6a as shown in FIG. 12 to complete a triangular package of cooked rice.

The label 72 has a discrete score 73 in alignment with the separable portion 21 of the outer film 2.

Wrapper ears 12, 12, 12 projecting from the respective three vertices of the triangular package are closed by thermal bonding to prevent the ingress of extraneous matter.

With reference to FIG. 13, the sheet of layer 40 can of course be seen through the transparent outer film 2 of the triangular package, and the ingredient 61 on the triangular mass of cooked rice 6a can also be seen through the aperture 41 in the layer sheet 40.

Further since a triangular frame 42 is formed around the aperture 41 by the sheet of layer 40, the contrast between the dark frame 42 and the ingredient 61 gives a vivid fresh appearance to the ingredient 61 to achieve an improved display effect.

[When the Mass of Cooked Rice is to be Eaten]

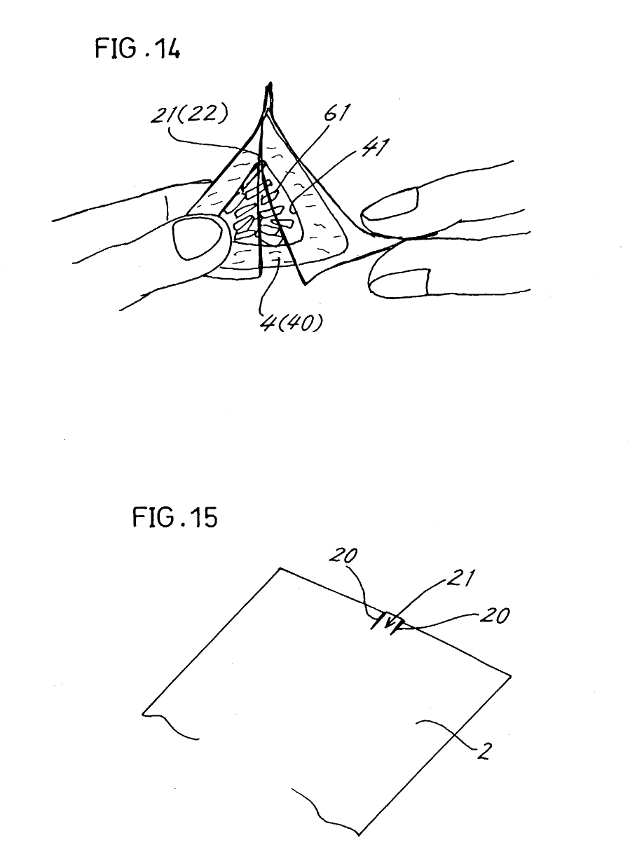

The triangular package is handled in the following manner to eat the cooked rice. With the wrapper 1 held by one hand at one side of the separable portion 21, the outer end of the other side thereof as held by the other hand is pulled toward a direction orthogonal to the separable portion 21 as shown in FIG. 14. The outer film 2 has the discrete score 22 and can therefore be torn apart readily along the score 22.

The outer film 2 is torn into two pieces along the separable portion 21. Half of the outer film 2 and one of the film pieces 31 of the inner film 3 thermally bonded to this film portion are pulled out together.

Next, while holding the exposed half of the triangular mass of cooked rice 6a with one hand over the layer sheet 40, the remaining half of the wrapper 1 around the rice 6a is pulled outward at an end portion thereof with the other hand, whereby the triangular mass of rice 6a is exposed as partly covered with the layer sheet 40. [Other Embodiments of Separable Portions]

FIGS. 15 to 17 show other embodiments of separable portions 21 of the outer film 2.

FIG. 15 shows an outer film 2 which is an oriented film which is easy to tear longitudinally thereof, and parallel cut lines 20, 20 are formed in the midportion of one end of the outer film 2. When opposite sides of the outer film are pulled away from each other at the opposite sides of the cut lines 20, 20, a narrow strip of the film between the cut lines 20, 20 can be removed to tear the film 2 apart.

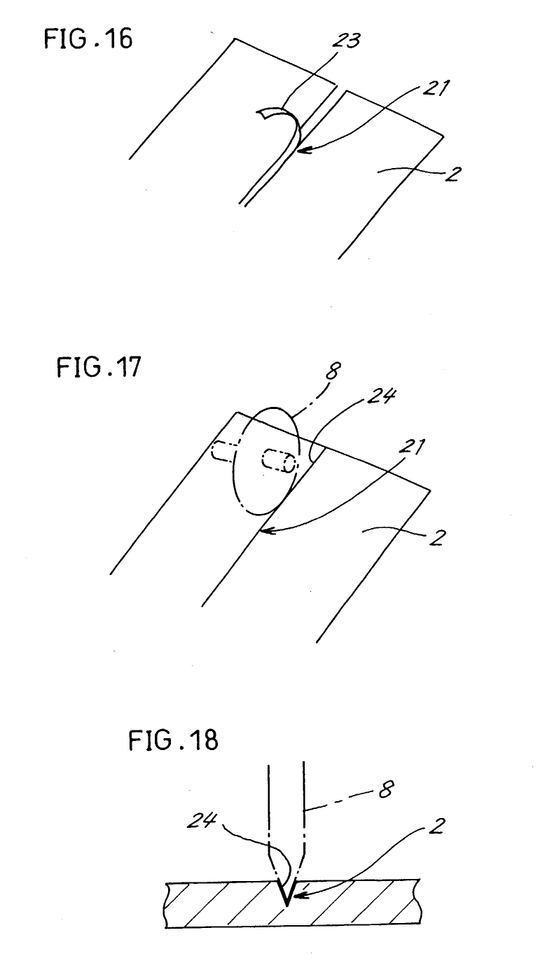

FIG. 16 shows a separable portion 21 provided by a so-called tear tape. The tear tape is formed by adhering a resin tape 23 of small width to the widthwise central portion of the outer film 2 over the entire length thereof. The outer film 2 can be torn apart with the width of the tape 23 by pulling one end of the tape 23 away from the film.

FIG. 17 shows a separable portion 21 provided by a heated line 24 extending over the entire length of the outer film 21. The heated line 24 is formed by rolling a roller 8 incorporating a heater (not shown) on the outer film 2 straight as seen in FIG. 18.

The heated line 24 melts the outer film 2 to a small depth, forming a groove defined by a wall having a reduced thickness, embrittled by heating and thereby made breakable readily.

Unlike the first embodiment shown in FIG. 1, the embodiments of FIGS. 15 to 17 do not have the score 22 extending over the entire length of the outer film and comprising cuts extending entirely through the thickness of the film, so that the film strip 5 need not be provided for closing the score 22.

Apparently the present invention can be modified and altered by one skilled in the art without departing from the spirit of the invention. Such modifications are included within the scope of the invention set forth in the appended claims.

What is claimed is:

1. A wrapper comprising a transparent outer film, a transparent inner film and a sheet of food sandwiched between the two films, the sheet of food having an aperture formed in a portion thereof corresponding to a front side of a mass of cooked rice.

2. A cooked rice package comprising a mass of cooked rice enclosed in a wrapper, the wrapper comprising a transparent outer film, a transparent inner film and a sheet of food sandwiched between the two films, the sheet of food having an aperture formed in a portion thereof corresponding to a front side of the mass of cooked rice.

3. A cooked rice package comprising a laterally elongated mass of cooked rice provided with an ingredient on a front side thereof, and the wrapper according to claim 1 and wound around the mass of cooked rice for packaging, the cooked rice package being characterized in that the outer film has a separable portion formed in a widthwise center part thereof and extending over the entire length thereof in the direction of winding, the inner film comprising two rectangular film pieces having inner side edges lapped over each other, the inner film having end covering portions projecting from respective longitudinal outer side edges thereof for covering respective end faces of the mass of cooked rice, the outer film and the inner film being joined along outer peripheries thereof at least except at a lap of the film pieces, the mass of cooked rice being placed on the inner film across the lap of the film pieces at right angles therewith, the wrapper being wound around the mass of cooked rice with an wound end fixed by fastening means, the aperture being positioned at a portion of the wrapper corresponding to the front side of the mass of cooked rice and permitting the ingredient to be seen through the aperture.

4. The cooked rice package according to claim 2 wherein the sheet of food has a length permitting opposite ends thereof to lap over each other on a rear side of the mass of cooked rice.

5. The cooked rice package according to claim 3 wherein the sheet of food has a length permitting opposite ends thereof to lap over each other on a rear side of the mass of cooked rice.

6. A cooked rice package comprising a triangular mass of cooked rice provided with an ingredient on a front triangular side thereof, and the wrapper according to claim 1 and having the triangular mass of cooked rice enclosed therein, the cooked rice package being characterized by folding the wrapper over opposite triangular sides of the mass of cooked rice, lapping opposite side portions of one end of the wrapper over respective opposite side portions of the other end of the wrapper, folding the resulting laps over the rear side of the mass of cooked rice and fixing the laps to the rear side by fastening means, the aperture being positioned at a portion of the wrapper corresponding to the front side of the triangular mass of cooked rice and permitting the ingredient to be seen through the aperture.

7. The cooked rice package according to any one of claim 2 wherein a recess is formed in the front side of the mass of cooked rice, and the ingredient is accommodated in the recess.

8. The cooked rice package according to any one of claim 3 wherein a recess is formed in the front side of the mass of cooked rice, and the ingredient is accommodated in the recess.

9. The cooked rice package according to any one of claim 6 wherein a recess is formed in the front side of the mass of cooked rice, and the ingredient is accommodated in the recess.

10. The cooked rice package according to any one of claim 2 wherein the sheet of food is a sheet of layer, and a peripheral edge of the sheet of layer defining the aperture provides a dark square to rectangular or triangular frame for the aperture.

11. The cooked rice package according to any one of claim 3 wherein the sheet of food is a sheet of layer, and a peripheral edge of the sheet of layer defining the aperture provides a dark square to rectangular or triangular frame for the aperture.

12. The cooked rice package according to any one of claim 6 wherein the sheet of food is a sheet of layer, and a peripheral edge of the sheet of layer defining the aperture provides a dark square to rectangular or triangular frame for the aperture.
